(19) United States
(12) Patent Application Publication
(10) Pub. No.: US 2022/0051488 A1
(43) Pub. Date: Feb. 17, 2022

(54) COMMUNICATION DEVICE FOR MANAGING ONE OR MORE ASPECTS OF A VEHICLE THROUGH REMOTE MONITORING

(71) Applicant: Alyn G. Brown, Nashville, IN (US)

(72) Inventor: Alyn G. Brown, Nashville, IN (US)

(73) Assignee: KAMP Technologies, LLC, Zionsville, IN (US)

(21) Appl. No.: 17/233,417

(22) Filed: Apr. 16, 2021

Related U.S. Application Data
(60) Provisional application No. 63/011,171, filed on Apr. 16, 2020.

(51) Int. Cl. G07C 5/00; G07C 5/08; G05D 1/00

(52) U.S. Cl. CPC G07C 5/008; G05D 1/0022; G07C 5/0808

(57) ABSTRACT

A communication device is provided for use with a mobile vehicle, having a drive system, and a plurality of sensors, including such things as a engine sensor drive system sensor, position sensor, and operational status sensor; and at least one controller for controlling the operation of one or more of these sensors. The communication device includes a processor mounted on the vehicle, and a transceiver in communication with the processor for sending data to and receiving data from a remote processor. The processor also includes input links that are capable of receiving data from the sensor and output links that are capable of communicating data received from the remote computer and transceiver to one or more of the controllers.

### CROSS REFERENCE TO RELATED APPLICATIONS

The present application claims the benefit of U.S. Provisional Patent Application No. 63/011,171, filed Apr. 16, 2020, the entire contents of which are expressly incorporated herein by reference.

### TECHNICAL FIELD OF THE INVENTION

The present invention relates to communication devices and, more particularly, to communication devices and techniques for remotely monitoring one or more vehicles, and controlling the operation of the vehicles in response to signals that are sent from the vehicle to a remote processor, such as a mobile phone, and are sent from the remote processor to the communication device that is mounted on the vehicle, and which is in communication with various of the vehicle sensors and controllers.

### BACKGROUND OF THE INVENTION

A large number of vehicles having engine systems and drive systems exist that include several parameters that are capable of being monitored so that a remote user can monitor aspects of the vehicle, such as its engine, drive system, position, operational status, the status of its accessories, and its attitude, so that the remote use can obtain a good picture of the status and operation of the vehicle.

By monitoring these parameters, the remote user can help to implement desired actions by the vehicle, monitor whether the vehicle is on schedule for particular task, monitor vehicular efficiency and cost effectiveness and also monitor the overall performance of the vehicle along with the compliance of the vehicle's operator with applicable regulations, locations, and routes, and also instructions given to the user by appropriate authority, such as governmental authorities and, more particularly, the employer or controller of the user.

Although devices exist that perform one or more of these functions, room for improvement exists. In particular, room for improvement exists in providing a device that is capable of providing a communication device between a vehicle having an engine and a drive system, and a remote user that enables the remote user to both monitor the operation of the vehicle, and also to control the operation of the vehicle, or at least certain aspects of the operation of the vehicle.

### SUMMARY OF THE INVENTION

In accordance with the present invention, a communication device is provided for use with a mobile vehicle having an engine, a drive system and a plurality of sensors, including at least a first, second, and third sensor selected from at least one of: (i) an engine sensor; (ii) a drive system sensor; (iii) a position sensor; (iv) an operational status sensor; (v) an accessory status sensor; and (vi) an attitude sensor. The vehicle also includes at least one controller for controlling the operation of at least one of the engine, drive system, and accessory.

The communication device comprises a processor mounted on the vehicle. The processor includes at least one input link and at least one output link and a communication link. A transceiver is provided in communication with the processor for sending data to and receiving data from the remote processor. The input link of the communication device is capable of receiving data from each of the first, second, and third sensors, and communicating the received data to the processor, the transceiver and the remote processor. The output link is capable of communicating data received from the remote computer and transceiver to the controller for cant oiling the operation of at least one of the drive system and engine.

One feature of the present invention is that as a communication device it can be connected to lawn equipment to allow two-way communication from a remote processor, such as a smart phone, to a powered lawn equipment device that is anywhere in the world that is capable of receiving a remote signal, such as a mobile telephone signal, a Wi-fi signal, or a satellite phone type signal. This feature has the advantage of enabling the user to know not only the location and current status of the lawn equipment device but also be in full communication with the vehicle.

Additionally, the device enables the user to monitor the CAN bus remotely and be notified of equipment failures or issues instantly. Additionally, the user can be alerted to any accidents, rollovers, or other potential issues that affect the device.

Not only can the user be notified of these, but the user can activate and deactivate the one or more of the vehicle's active operating parts, such as its accessories, its engine, or its drive system. Further the device can provide maintenance reminders to the user.

It is also a feature of the present invention that it is capable of being connected to off-highway equipment, to allow two-way communication including the receipt of material sensed by the sensors, and the transmitting of orders to the controller of the device that affect the operation of the device. Such connected off-highway equipment can include things such as tractors, excavating equipment, bulldozers, earth movers, forklifts, steamrollers, bricklayers, pavers, and other such remote equipment. This feature also has the advantage of enabling the user to monitor the CAN bus remotely, be notified of equipment failures or issues instantly, be alerted to any accidents, rollovers, or other potential issues, and to activate or deactivate the vehicle operational components, such as the drive system, motor, and the like.

A further feature of the present invention is that the communication device can be coupled to a water-borne device, such as boat, yacht or water craft. In addition to those advantages that are provided to the lawn care device and off-road equipment discussed above, the communication device when coupled to a water craft enables the user to monitor the NMEA 2000 bus; tie into analog gauges and other devices; be integrated with bilge, fumes, smoke or other sensors to be alerted of potential issues and other problems that the devices face.

Additionally, the device, through suitable controllers, can activate and deactivate the vehicle and its accessories to perform such functions such as pre-cooling the boat by turning on the air conditioner prior to the time when the user arrives at the boat; turning the water heater on and off, and monitoring battery and fuel status.

A further feature of the present invention is that it can be connected to power sports and recreational vehicle products to allow the device to achieve many of the same advantages as when connected to a water craft.

In an alternate embodiment of the present invention, the device can be connected to a non-moving item, such as a home of a user, for enabling the remote user to monitor the condition of devices at the home and the status of devices at the home, such as basement water level, basement humidity, garage door open or closed position, power usage, humidity and temperature of the dwelling, thermostatic control, airflow through the house, and other statuses, such as the status of whether the oven and stove are turned on or turned off.

In a most-preferred embodiment of the present invention, the communication device is capable of providing device management, analytics and connectivity, and serial bus interface, for vehicles as different as off-highway vehicles, marine vehicles, lawn equipment, automobiles, robotics, and process equipment. Preferably, a 12-channel analog input/output device allows the communication device to convert almost any existing device to a connected device.

To reduce cost, the preferred embodiment includes narrow band connectivity that connects through global phone technology, and may include direct connection with Bluetooth, and GPS positioning through a GPS device. Further, movement and acceleration sensors can be provided, along with an application placeable on the remote device, such as the mobile phone, to control the operation of the device.

In a most-preferred embodiment, built-in sensors can be provided that automatically alert remote-monitoring systems, such as an OnStar advisor. With data provided by the sensors, the device will be capable to communicate information to a remote user provides a prediction of the severity of an accident or other problem that the device may have so that advisors at the remote monitoring system can help make first responders more aware of the possibility of the severity of the action in which the vehicle was involved.

This monitoring is especially useful in rollover or accident situations. In stolen vehicle situations, the communication device can provide location data about the particular vehicle to thereby help authorities retrieve the vehicle and, possibly, find the person who stole the vehicle.

In a most preferred embodiment, the communication device should be capable of communicating data to the remote user, which will enable the remote user, through suitable software, to order correct parts for the device for those parts that are reported as breaking down by the communication device, provide the user with notifications of when maintenance is due, schedule maintenance with a local dealer or repair shop when appropriate, and provide on-demand diagnostics.

These and other features of the invention will become apparent to those skilled in the art upon a review of the drawings and detailed description presented below which represent the best mode of practicing the invention perceived presently by the applicant.

### BRIEF DESCRIPTION OF THE DRAWINGS

In the drawings, FIG. 1 is a diagram of the overall system;

FIG. 2 is a simplified block diagram of the overall system;

FIG. 2A is a block diagram of the overall system;

FIG. 3 is a block diagram of CPU/Transceiver;

FIG. 4A is schematic perspective view a vehicle that includes the CPU/Transceiver device of the present invention;

FIG. 4B is a schematic top view of a vehicle that includes the CPU/Transceiver device of the present invention;

FIG. 5 is a schematic perspective view of a vehicle that includes the CPU/Transceiver device of the present invention;

FIGS. 5A-5B are various views of vehicle components that incorporate the present invention;

FIGS. 6A-6B are schematic views of the device on a typical recreational vehicle;

FIG. 7 is a block diagram of a CPU/Transceiver on a typical yacht;

FIGS. 7A-7B are various schematic views of the CPU/Transceiver device installed on exemplary machines;

FIG. 8 is a perspective view of CPU/Transceiver hardware;

FIG. 9 is a block diagram of the CPU/Transceiver device; and

FIG. 10 is a perspective view of additional modules.

### DETAILED DESCRIPTION

The communication devices of the present invention are described and shown in the figures. In the figures, the following numbers refer to the following parts.
10—User
100—Example Off Highway Vehicle
150—Exemplary Lawn Mower
152—Lawnmower Engine
200—Exemplary RV Trailer
250—Exemplary Yacht
300—Exemplary Cloud
310—First Gateway
312—Second Gateway
320—Internet
330—Data storage and processing
400—Mobile smart device
500—CPU/Transceiver Device
510—CPU/Transceiver Housing
520—CELL MODEM
522—SIM Card Holder
524—LTE Antenna
522—Optional Blue Tooth Antenna
524—Optional Wi-Fi Antenna
530—GPS Module
532—GPS Antenna
540—IMU Module
542—Voltage Monitor
550—CPU/Transceiver Battery
560—Power Input
562—Voltage Regulator
630—2^{nd} Voltage Regulator
570—CAN Transceiver
580—Microprocessor
590—CAN Connection
592—UART Connection
594—Micro USB Connection
596—Auxiliary I/O
598—LED Indicator Output
599—Switch input
600—Vehicle Power connection
700—Vehicle CAN connection
720—Vehicle side Can Connector
800—Vehicle Analog Connection
900—Optional Module
910C—Can Cable
920—Can T
1000—Typical Control Panel
1100—Typical Indicator Gauge (Such as water level)
1102—Typical Indicator Gauge (Such as waste level)
1104—Typical Indicator gauge (such as fuel level)
1106—Typical Indicator Gauge (Such as Voltage)
1200—Typical Switch
1202—Typical Switch 2
1204—Typical Switch 3
1206—Typical switch 4
1208—Typical Switch 5

### INTRODUCTION

The present invention is used with vehicles having engines and drive systems. By way of nonlimiting example, these vehicles may comprise a service fleet that carries-out the business of an enterprise and are each remotely monitored and managed while concurrently dispatched by the enterprise. Such an enterprise might provide certain services via this fleet, such as yard/landscape care (i.e. the fleet includes several lawnmowers or like machinery); delivery of goods; construction, maintenance, repair, and/or renovation of buildings; equipment installation, repair, and/or maintenance (e.g. home appliances, outdoor electric power lines, industrial machinery, communications cabling, in-ground pipelines, etc.); entertainment services where the fleet may comprise off-road vehicles, watercraft, snowmobiles or the like for rent; and/or over road vehicles, watercraft, and/or aircraft directed to transportation.

In one form, a modular system/platform comprises a device and a system that allows the user to convert a vehicle into a type of connected device capable of wireless two-way communication with a remotely located part. The platform includes, a modular system, a mobile software application and a modular device which contains a CPU and Transceiver and allows two-way remote communication and control from your smartphone to your vehicle.

In the case of a road vehicle, the CPU and/or transceiver may be at least partly provided with an Engine Control Unit (ECU) or dedicated equipment separate from the ECU. This arrangement enables a party to remotely monitor vehicle location/route and/or speed; determine vehicle maintenance/repair conditions, evaluate vehicle collision/accident status based on one or more on-board inputs (e.g. airbag deployment detection, a rapid deceleration as provided by one or more accelerometers, etc.); temperature of a vehicle passenger compartment and/or a refrigerated cargo space, humidity. Further, it allows the user to control everything from lights, fans, and vents, to AC, pumps, locks.

One implementation interfaces the vehicle CPU/Transceiver with other vehicle electronical equipment a vehicle serial bus that typically is accessed by vehicle electronic equipment with vehicle communication bus, that may be standardized like a Controller Area Network (CAN) bus type defined by the International Organization for Standardization (ISO) document designated as ISO 11898. Such an arrangement allows true two-way communication between your mobile device to your vehicle from virtually anywhere in the world.

In a most preferred embodiment, the platform device includes a CPU and Transceiver that can be coupled to a machine, and can sense the state of the machine, and of other peripheral things connected to the device. The Device can also send electronic communications to the machine, and allows for remote access, control, and updating of electronic things that are part of the machine.

A modem on the Device allows the CPU to transmit and receive data about the device to and from the cloud. The radio signal from the device is then connected via wireless radio signal to the Internet. The signal travels through the Internet to a hosting service, and to a second gateway. The second gateway allows for a remotely located user to connect via smart device (such as mobile Phone).

The first and second gateways can comprise things such as cell phone towers, Wi-F hard lines, satellite, wireless radio, or other methods for connecting devices to the. Internet.

By way of transition to the remainder of the present application, the present application may provide information to clarify, supplement, define, exemplify, or otherwise advance understanding of certain “terminology” with a “defining description” that may appear in in any order Potentially, such terminology could be: any word (e.g. compound, blend, portmanteau, acronym, abbreviation, initial word forms), or other symbology (e.g. one or more alphanumeric characters, punctuation marks, mathematical expressions, and/or other marking), alone or in any phrase, character string, concatenation, mixture, multiple, or combination of the foregoing.

The terminology and defining description can be associated in any manner such as: linking/referral language (e.g. a verb with any other word optional); paired punctuation (e.g. (parentheses), ‘single’ or “double” quotes, «guillemets» [brackets], {braces}, —dashes—, etc. . . . ); a single interposed marking e.g. a colon: dash—, ellipsis . . . , and/or contrasting character pitch, letter case, small caps, etc.

A defining description can specify terminology meaning in any manner, including: direct statement/explanation, delineation of meaning scope/limits, recitation of one or more examples (e.g. a positive/inclusive example type, a negative/exclusive example type, or both), by comparison and/or contrast to other terminology/meanings, etc.; originate new terminology in exercise of a patentee's lexicographic option (e.g. one or more new words, symbols, markings, signs, operators, or combinations of any of the foregoing) with the meaning specified by the defining description.

A defining description can specify an abridgement representative of a longer/fuller form per the defining description (e.g. an abbreviation, acronym, initials, blend or compound word, etc.); specify/identify/represent a value that may be constant or subject to a tolerance or other degree of uncertainty; a mathematical variable with potential to vary as to at least two values either of a numerically quantifiable variety (e.g. either a continuously or a discretely varying numeric value) or a qualitative variety with potential to vary in value non-numerically as to two or more discrete categories (qualitative discrete non-numeric value variation).

Optionally, a defining description can represent a measurable or otherwise quantifiable attribute, trait, quality, property, characteristic, shape, movement, direction, progression, transformation, or the like of any physical or theoretical object, composition, process, application, or the like by mathematical expression, function, variable, approximation, probability/statistical characterization, scalar-based (one-dimensional) or multi-dimensional array (e.g. vector, tensors, matrices, etc. of two or three dimensions, or more) a combination or multiple of any other foregoing; or the like identified with the terminology by equivalence as in Attribute=A, paired punctuation as in Attribute (A), adjacency as in Attribute A, and the like.

Any meaning of terminology defined herein applies in addition to any other meaning of the associated terminology including any ordinary and customary meaning and any meaning as understood by those of ordinary skill in the art pertaining to the patent application to the extent consistent to do so with the meaning defined herein applying as an alternative to any inconsistency. Further, a definition applies to a given occurrence of the terminology without regard to format, any accompanying punctuation, or any difference relative to another occurrence (including occurrence with the defining description) unless explicitly stated to the contrary.

In addition, a terminology definition shall apply to each occurrence of the terminology unless: the defining description of such terminology expressly specifies otherwise or a subsequent defining description differs in one or more respect to redefine the same terminology (a “redefinition”) in which case such redefinition shall apply to any further occurrence of the terminology for the remainder of the present application unless specified otherwise by its defining description or the terminology is subject to further redefinition.

The present application is not all-inclusive or exhaustive—being merely representative and non-exclusively exemplary. From the perspective of those of ordinary skill in the art pertaining to the present application, any patent claim that follows or innovation otherwise described herein can be practiced without one or more details included in the description and/or with one or more additional features, elements, aspects, or the like not recited therein. Any obvious addition, modification, deletion, combination, or other variation of the present application teachings is also within the scope of any properly construed patent claim appended hereto or innovation otherwise described herein. Accordingly, the information provided herewith (including any drawing figure) is not intended to narrow the scope of any patent claim that follows—as compared to the scope of such patent claim defined by the language recited therein when properly construe.

The following description sets forth various details in writing to provide a thorough understanding of the principles and subject matter of the present application including any patent claim that follows and any innovation otherwise described herein. To promote this understanding, the description refers to certain aspects—using specific language to explain the same accompanied by any drawing figures to the extent the subject matter of the present application admits to illustration. If a given aspect of the present application subject matter is well-known, less detail about such given aspect may be presented by way of illustration, writing, or both as compared to any aspect that is unknown (or at least not as well-known) to sharpen clarity of this description. This description and any attendant drawing figures present the subject matter of the present application by way of one or more examples, forms, instances, or the like; and sometimes includes one or more alternatives, modifications, or variants of the same—but the description is not intended to be all-inclusive.

Instead, it is merely representative and exemplary. Accordingly, the description sets forth representative examples only and does not constrict, limit, restrict, reduce, restrain, or otherwise narrow the coverage/scope of any patent claim that follows nor that of any innovation otherwise described herein.

The present invention allows a user to embrace the 4^{th} industrial revolution and take advantage of the Digital Transformation. The platform approach of the present invention allows a business to navigate the technologies that are available and find ways for a business and product users to gain useful data and increased revenue with the right Connected Device strategy. The Present Platform provides an organization with a jump start In the Connected Device Arena. The CPU/Transceiver un-complicates the Connected Device Arena and helps to take the guess work out of Machine-to-Machine and IoT connectivity, management and security by creating an integrated ecosystem accessible through RESTFul APIs.

The present invention takes advantage of the opportunities that the digital transformation has presented by helping users quickly, and efficiently take their products and machines to the next level, By turning the machines and devices into Connected Devices, the user will be able to collect data in ways that were never before possible. Among the data that can be collected are data about how the machines are being used, how much fuel is being consumed, how much vibration they experience, what actual forces are being experienced by the operator on a per use basis, Additionally, information can be obtained relating to whether the machines are being run efficiently, how much fuel is used per job site, how would switching to full electric impact the operation, and the costs of running full electric.

This data will allow the user to improve the next generation of products, decrease warranty issues, and create products that will be the best ever created for the user.

Connected devices will give customers the opportunity to save money and increase efficiency by automating reporting. Customers may be able to take advantage of automating regulatory reporting based on their Connected Device usage and even be set up to link directly to existing systems such as billing and scheduling software.

The Connected Devices of the present invention will allow real-time maintenance monitoring and notifications to become a reality. The Connected Device can transmit use data directly to the cloud where advanced algorithms can calculate when maintenance is required based on the actual use of the Connected Device. Increased time between failures, and decreased downtime will translate directly into increased revenue for the users. No more guessing at maintenance or basing maintenance on a date. The Connected Device will tell you when it needs maintenance.

Once the use data has been collected from the Connected Device, the data can be used in creative ways. The user can employ the data to predict failures by integrating Al based systems to analyze the data and start making predictions. Other uses for the data exist. For example, one can compare use data to weather data to find out how the Connected Device performs based on the weather. One can compare the Connected Device use data to the price of fuel, or use data can be combined with geographical data, compared with economic data, compared with political data. Once we have the data available, the possibilities are endless.

Fleet Tracking exists, but with the increased proliferation of IoT devices the capability is now a reality for your Connected Device. The users and employees will know exactly where the Connected Mower is, and how it is being used at any time.

One of the concerns that dealers all seem to have is that they are losing sales of their devices, sales of maintenance and repair parts, and sales of services to online retailers. Users of the machines are ordering more of their parts from online sources and doing more of their maintenance outside of dealer networks. By creating the connection to the device and to the end user, the OEM's and the dealers will have direct access to the end user or the manager of the equipment! This can be tied in with the maintenance tracking, and predictive maintenance. Under the present invention when a Connected Device is in need of maintenance, it can notify both the user and the dealer. The notification may include a direct link to the dealer or parts ordering or a direct link to the dealer to schedule service. A savvy dealer may even create a loaner program that would allow at the dealer to drop of a loaner machine while they pick up the user's Connected Device for maintenance.

Accidents occur with many machines, and sometimes they are unavoidable, but there are ways that the IoT technologies of the present invention can help. The Platform can detect what it is doing, what the connected machine is doing, and where it is located. It also will know if it the Device has experienced a severe impact, has had a roll over event or has flipped. This information can be used to trigger emergency calls ore request help. A panic button feature could also be added to allow the user to request assistance in an emergency situation.

Turning now to FIG. 1 we will see a representation of the complete system. The complete system consists of a CPU/Transceiver module 500, which is connected to some type of machine such as an Off Highway Vehicle 100. The CPU/Transceiver 500, sends and receives data and commands wirelessly through a Internet of Things Cloud Connection 300. A user 10 is able to interact with the vehicle 100 by accessing the Cloud Based 300 IoT hub through a mobile device 400 app 420. The Connected Off Highway Vehicle 100 when connected to a connector 500, allows two way communication to and from a smartphone 400 via the cloud 300.

Turning now to FIG. 3, a CPU/Transceiver module 500 with GPS module 530 will allow the user 10 to access the location of vehicle 100 with the smart device 400. The user 10 will use the Mobile App 420 on the mobile device 400 to access the cloud 300 and retrieve position data from the Global Positioning Satellite (GPS) module 530 included with the CPU/Transceiver 500.

The user 10 will also be able to retrieve and send commands to the Vehicle 100's CAN BUS through the smart device 400 mobile app 420. Failures of components, or component errors transmitted to the CAN bus can be sent to the Cloud 300 via the CAN bus from the CPU/Transceiver 500 and accordingly to the mobile phone 400 of user 10. If an optional IMU sensor 540 is used, an alert can be sent to the mobile device user 10 to alert the mobile device user of any vehicle roll overs.

Remote programming of the Can Bus is possible through the connection. Auxiliary components of the machine 100 can be activated or deactivated remotely. Maintenance reminders can be sent from the machine 100 to the cloud 300 through the CPU/Transceiver 500.

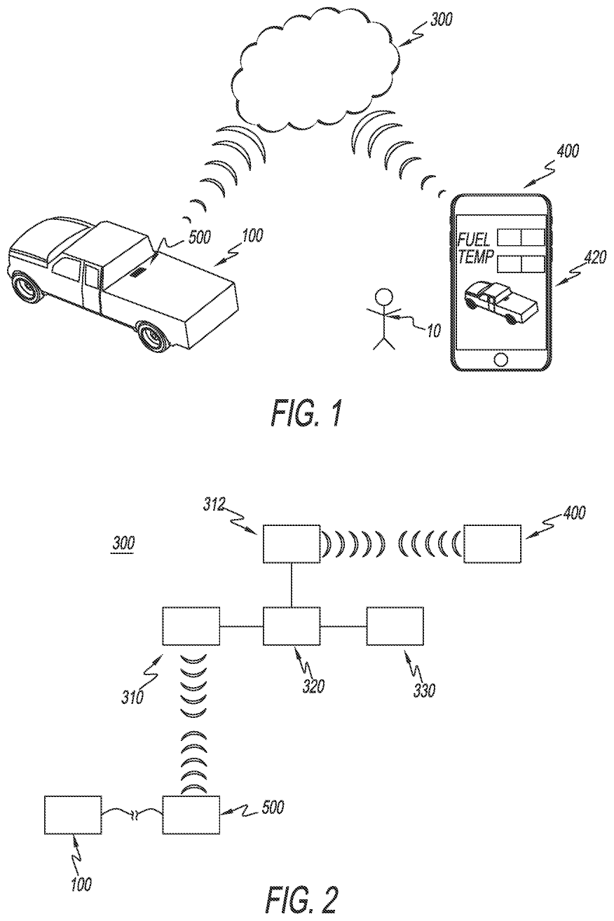

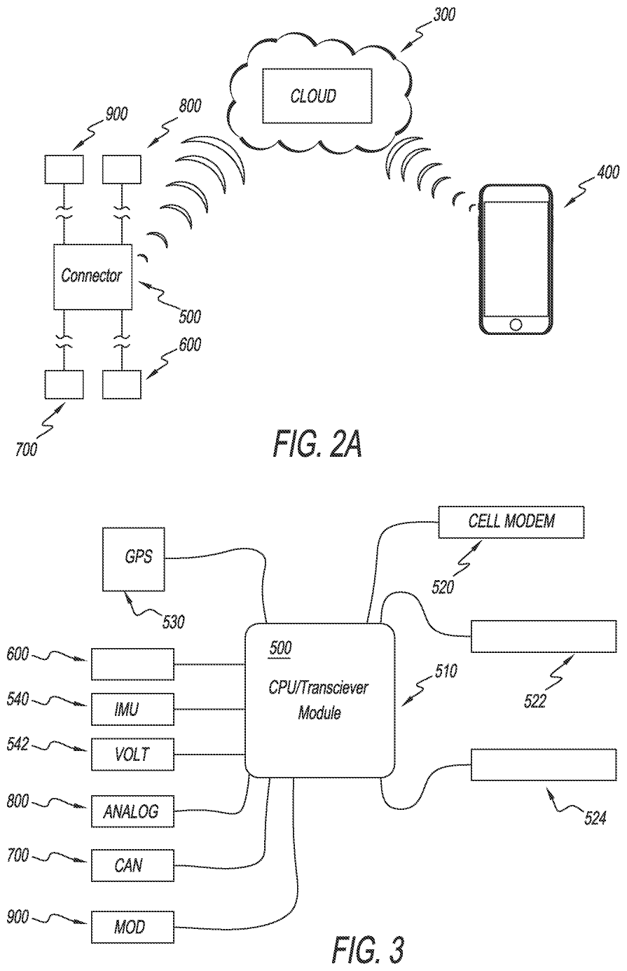

Smart algorithms running on the IoT Hub, and AI Based Machine Learning, can be used to predict failures, and allow the user 10 to perform predictive maintenance on his connected machine 100 before problems occur. Turning now to FIG. 2, you will see a block diagram of an exemplary Cloud 300. The Cloud 300 comprises a gateway 310 connecting the wireless connector 500 to the internet 320. The Gateway 310 can consist of a Bluetooth connection, a Wi-Fi Connection, or a Cell phone Connection.

A preferred embodiment of the invention is a cell gateway connection. The internet 320 is then connected to the Internet of Things (IoT) hub 330. The CPU/Transceiver 500 is in wireless communication with the Gateway 310. The Gateway 310 is then connected either wirelessly or through hardwire to the internet 320. The internet is in electronic communication with the IoT hub 330. A mobile device 400 is in connection with a second gateway 312. The second gateway is in connection with the internet 320.

In this preferred embodiment, the CPU/Transceiver 500 communicates information to and from the connected machine 100 to and from the gateway 310, through the internet 320, to and from the IoT hub 330. The Mobile Device 400 Communicates information and commands to and from the second gateway 312 to the internet 320 to and from the IoT hub 330. This allows the mobile device 400 to be in communication with the CPU/Transceiver 500 and the connected machine 100.

Turning now to FIG. 2A you will see a block diagram of the system. The Mobile Device 400 is in communication with the Cloud 300. The cloud is in communication with the CPU/Transceiver 500. The CPU/Transceiver is connected to a plurality of connections comprising Vehicle Power connection 600, Vehicle CAN connection 700, Vehicle Analog Connections 800, and Optional Modules 900.

Optional Modules 900 may comprise Inertial Measurement units, Temperature sensors, humidity sensors, voltage sensors, video sensors.

Turning now to FIG. 3 you will see a block diagram of the CPU/Transceiver components. The CPU/Transceiver components comprise a cell antenna 520, an optional Bluetooth Antenna 522, an optional Wi-Fi antenna 524, an optional GPS 530, an optional inertial measurement unit 540, an optional voltage senor 542, a plurality of analog and serial connections 800, a can bus connection 700, and an expandable port for future modules 900.

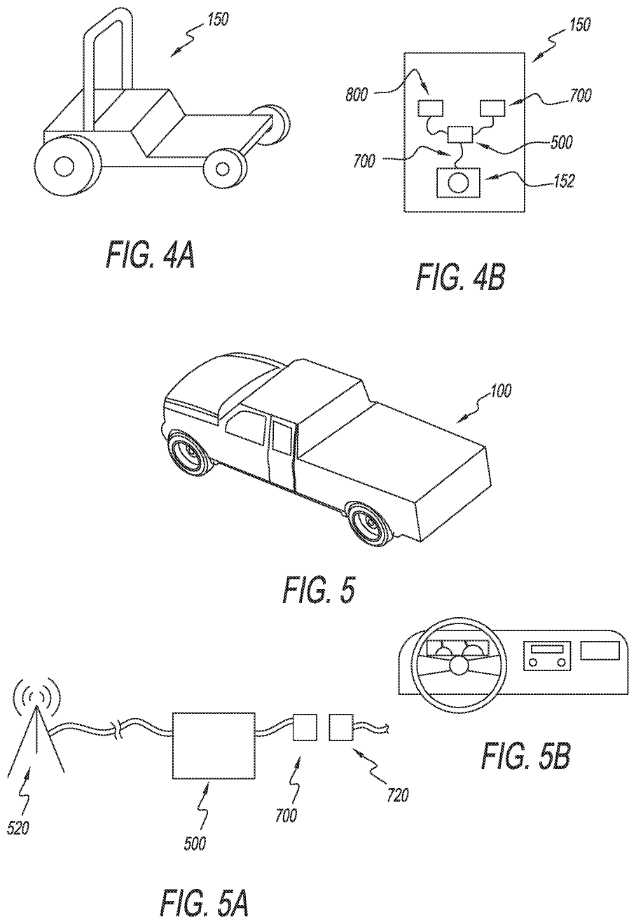

FIGS. 4A and 4B show a perspective view and a top view of an exemplary lawn mower 150 with the CPU/Transceiver 500 installed thereon. The lawn mower 150 includes a lawn mower engine 152. The lawn mower engine 152 is connected to the CPU/Transceiver 500 via a CAN BUS connection 700. The CPU/Transceiver 500 is also connected via the CAN Bus 700 to lawn mower digital components and via analog connection 800 to lawn mower analog components.

FIGS. 5A and 5B show a basic installation of a CPU/Transceiver device 500 connected to a Vehicle 100 through the Vehicle's Can Connection 720. In this installation, the Connector 500 is powered from the vehicle 100's Can Bus 720. The CPU/Transceiver 500 is connected to the Cloud 300 through the CPU/Transceiver 500's internal Cell module and antenna 520.

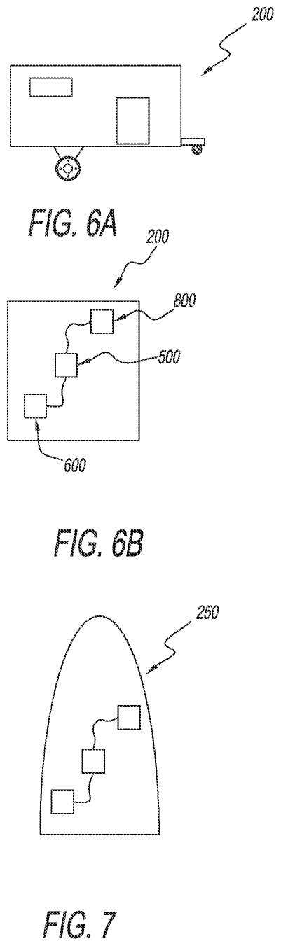

FIGS. 6A and 6B show an Exemplary Recreational Vehicle (RV) 200 Connected to the Cloud 300 by a CPU/Transceiver 500. In this configuration, the object of the present invention can interface with various devices and sensors on the RV 200. The CPU/Transceiver 500 is shown connected to power 600 and to analog components of the RV 200 via the analog connection 800.

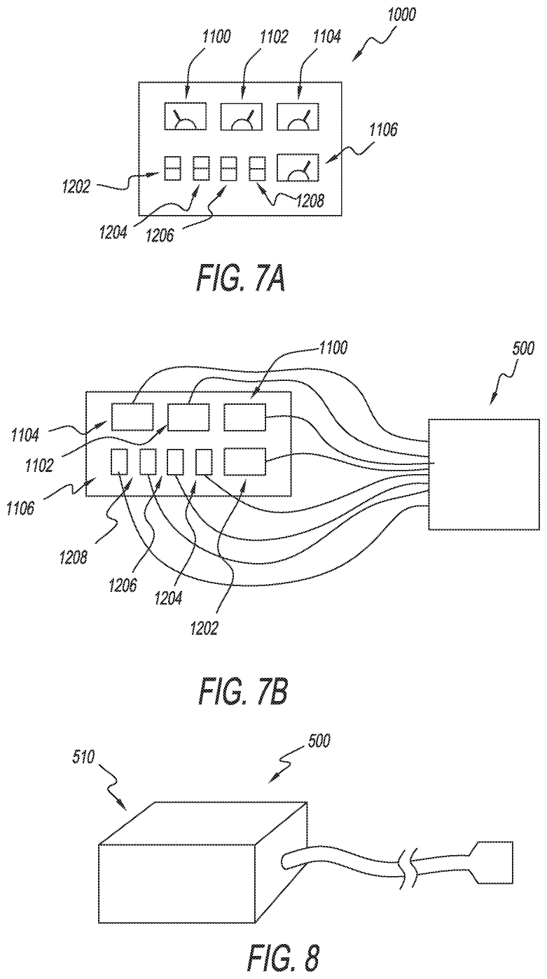

FIG. 7 shows a schematic view of an exemplary yacht 250 with the present CPU/Transceiver 500, while FIGS. 7A and 7B show a front and rear view of a typical control panel that would be found in a typical yacht or RV. The exemplary electrical control panel 1000 comprises a plurality of gauges 1000, 1102, 1104, 1106, and a plurality of switches 1202,1204,1206,1208. The Gauges can be gauges connected to sensors that measure things like tank levels, fuel tank levels, water tank levels, gray water tank levels, voltage, current, or many other measurable parameters. The switches typically comprise on/off switches for electrically controlled devices like pumps, motors, vents, door or hatch openers, fans, and other devices.

Each of the gauges 1102 (and here, their sensors) can be electronically connected to the CPU/Transceiver 500. The electronic connection allows the CPU/Transceiver to monitor the electrical signal that the sensor sends to the gauge, and transmit that signal to the Cloud 300.

Each of the switches 1202 can be electronically connected to the CPU/transceiver 500. The switches 1202 can be wired to the CPU/Transceiver 500 to allow the CPU/Transceiver to monitor the position of the switch, or can be wired to control the action output of the switch. In this configuration the CPU/Transceiver device 500 can be used for remote monitoring and control of systems that are on the RV 200.

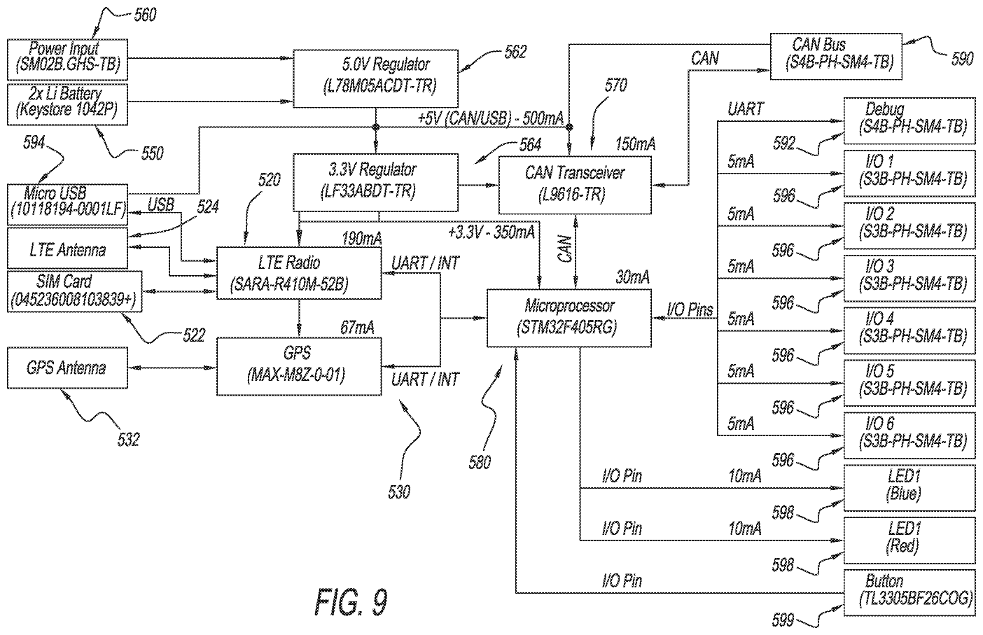

FIG. 9 shows a preferred embodiment of the CPU/Transceiver assembly of the present invention. As seen in FIG. 8, the CPU/Transceiver 500 has a housing 510 and a multi-pin CAN Bus connector. The housing comprises the circuit board, antennas, connectors, batteries, and other items necessary, and as shown in FIG. 9.

The GPS antenna 532 and Cellular antenna 524 may be incorporated into or onto the housing 510, or they can be mounted remotely. Remote mounting may be necessary depending on the application and the location of the CPU/Transceiver box 510 to ensure that there is a good wireless radio signal from the GPS satellites and to and from the Cellular Antenna.

FIG. 9 shows a block diagram of the components of the present invention. In a preferred embodiment, these components are configured to be located on a single electronic board. In an alternate embodiment, the components may be on separate circuit boards.

A microprocessor 580 is in electronic communication with a Cellular Radio 520. The microprocessor 580 sends electronic signals to the Cellular Radio 520. The Cellular radio 520 converts the electrical signal into a packet of information that can be transmitted wirelessly through the cellular network and to the IoT Hub.

The Microprocessor 580 is also connected to a plurality of inputs and sensors. In a preferred embodiment, the microprocessor 580 is in electronic communication with a GPS module 530, a CAN Transceiver 570, a plurality of configurable Input/output connections 596, and a plurality of indicator LED light 598.

Electrical Power is supplied to the microprocessor and to the peripheral components from a plurality of voltage regulators. In a preferred embodiment, a first regulator 562 is used to convert vehicle level power to 5 v, and a second regulator 564 is used to convert the 5 v power to board level 3.3 v power, In a preferred embodiment, a lithium Ion battery 550 is included to provide backup power. External power is obtained from the vehicle from a power connection 560.

It is desirable to have a system that allows users to add upgrade in the future. When new technologies and devices are released, it is desirable to be able to easily add them to the present invention.

“Plug-and-play” functionality is desirable, and is achieved in the object of the present invention by allowing modules to be expanded via the serial connections of the board, and future software updates to be transmitted to the object of the present invention over the cellular network.

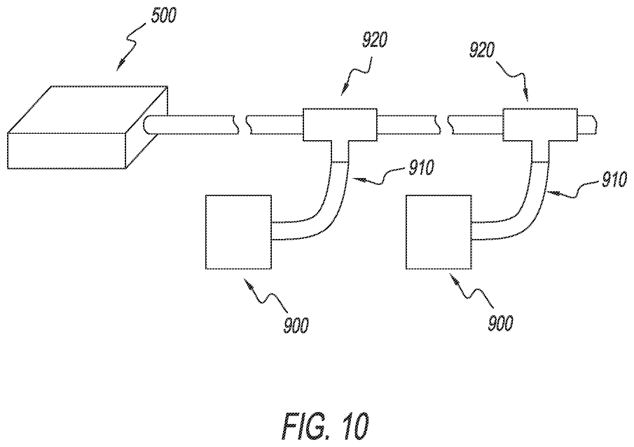

FIG. 10 illustrates how additional modules 900 can be connected to the main CPU/Transceiver 500 via serial bus. In a preferred embodiment, additional modules are connected through the CAN Bus serial bus of the object of the present invention.

Expansion modules may comprise modules such as GPS modules, additional sensor Modules, Autonomous Modules, motor control modules, vision sensor modules, and others. In a preferred embodiment, additional modules 900 are added to the device 500 by electrically connecting through the Can Bus. A plurality of CAN T's 920 can be utilized to add a plurality of modules 900.

Any conjecture, discovery, experiment, estimation, finding, guesswork, hypothesis, idealization, investigation, model, operating principle or mechanism, prophetic description, representation, speculation, theory, test, test or experimental results, or the like relating to any aspect of the present application is provided to enhance understanding of the subject matter thereof without restricting any patent claim that follows—except to the extent the foregoing is expressly and unambiguously recited in such patent claims. The organization of application content under one or more headings aims to enhance understanding of such content and promote application readability, but these headings are not intended to affect the scope, meaning, substance, or “prior art” status of such content, except to the extent (if any) unambiguously expressed to the contrary in connection with each specific instance thereof.

No patent claim hereof or innovation otherwise described herein should be understood to include a clause with a “means for” or “step for” performing a function (e.g., means plus function clause or step plus function clause, respectively), unless expressly specified by reciting within such clause “means for . . . ” or “step for . . . ” followed in close proximity by a function in gerund (“-ing”) form. Except to the extent expressly indicated to the contrary, aspects recited in a process or method claim (such “aspects” collectively refer to any acts, actions, activities, clauses, conditions, conditionals, contingencies, elements, events, features, gerunds, limitations, operations, phases, phrases, stages, statements, steps, relationships, or the like) may be performed in any order or sequence irrespective of cardinality or otherwise.

Furthermore, any two or more of such aspects may be performed simultaneously, concurrently, or overlapping in time. Indeed, no order, sequence, concurrence, simultaneity, or overlap of two or more of such aspects results just because the process or method claim: (a) recites one of these aspects before another within the claim language, (b) precedes the first occurrence of an aspect with an indefinite article (“a” or “an”) or no article (as is commonplace for a plural noun, a proper noun, a mass or uncountable noun, an abstract noun, a number, a noun followed by a number, an prepositions, any, all, some, many, several, another, each, and certain other types of terminology in the English language) followed by a one or more subsequent occurrences of such aspect preceded by a definite article (“the” or “said”), (c) ordinal numbers in word form (first, second, third, . . . ) each precede the same identifier, descriptor, item, or the like to distinguish between them (e.g., first device, second device, third device, . . . ; first one of the modules, second one of the modules, third one of the modules, . . . , or the like), or (d) the process/method claim includes alphabetical or cardinal number labeling to improve readability, organization, or the like—except to the extent the content of such claim properly construed unambiguously imposes a particular order, sequence, concurrence, simultaneity, or overlap as to two or more of its aspects,

To the extent a particular order, sequence, concurrence, simultaneity, or overlap is imposed as to certain aspects of a process/method claim, but not all aspects of such claim, the same does not impose any order, sequence, concurrence, simultaneity, or overlap as to any other aspect listed before, after, or between such certain aspects.

The subject matter of the foregoing description and any drawing figures of the present application is not all-inclusive or exhaustive—being merely representative and non-exclusively exemplary. With respect to any patent claim that follows or innovation otherwise described herein, those of ordinary skill in the art pertaining to the present application will recognize that the same can be practiced without one or more details included in the description; and will also recognize such innovation or patent claim can be practiced with one or more additional features, elements, aspects, or the like not recited therein.

Further, any obvious alteration, modification, or variation that may result from the present application teachings is also within the scope of any properly construed patent claim appended hereto or innovation otherwise described. Accordingly, the information provided in the preceding writing and/or any accompanying drawing figure is not intended to constrict, limit, restrict, reduce, restrain, or otherwise narrow the scope of any patent claim that follows-as compared to the scope of such patent claim defined by the language recited therein when properly construed. Presented below are some examples of the use of the present invention and the features it can provide.

### EXAMPLE 1

### Lawn Equipment

When connected to Lawn Equipment, the platform of the present invention allows two-way communication from your smartphone to your powered lawn equipment anywhere in the world.
You can not only know the location and current status of the connected device, but you can also have full communication with the vehicle.
You can monitor the CAN bus remotely
BE notified of equipment failures or issues instantly
Be alerted to any accidents, roll overs, or other potential issues.
Activate and deactivate the vehicle or accessories on the vehicle.
Maintenance reminders

### EXAMPLE 2

### Off Highway Equipment

When connected to Off Highway Equipment, the present invention allows two-way communication from your smartphone to your tractors, excavating, or virtually any other outdoor connected device power equipment anywhere in the world.
You can not only know the location and current status of the piece of equipment, but you can also have full communication with the vehicle.
You can monitor the CAN bus remotely
BE notified of equipment failures or issues instantly
Be alerted to any accidents, roll overs, or other potential issues.
Activate and deactivate the vehicle or accessories on the vehicle. You
Maintenance reminders

### EXAMPLE 3

### Watercraft

When the present invention is Connected to Boats, Yachts, or other watercraft.
You can not only know the location and current status of the boat, but you can also have full communication with the vehicle.
You can monitor the NMEA 2000 bus remotely.
Tie into analog gauges and other devices if desired
BE notified of failures or problems instantly
Integrate with bilge, fumes, smoke, or other sensors to be alerted of potential issues.
Activate and deactivate the vehicle or accessories on the boat.
   Pre-Cool the AC
   Turn off the Water Heater
   Monitor Battery and Fuel status
Maintenance reminders

### EXAMPLE 4

### Power Sports Equipment

When the present invention is Connected to Power Sports equipment such as motorcycles, side-by-sides, quads, or Recreational Vehicle Products such as Campers, RV's, and trailers.
You can not only know the location and current status of the vehicle, but you can also have full communication with the vehicle.
You can monitor the NMEA 2000 bus remotely.
Tie into analog gauges and other devices if desired
BE notified of failures or of problems instantly
Integrate with bilge, fumes, smoke, or other sensors to be alerted of potential issues.
Activate and deactivate the vehicle or accessories on the boat.
   Pre-Cool the AC
   Turn off the Water Heater
   Monitor Battery and Fuel status
Maintenance reminders

### EXAMPLE 5

### Process Monitoring and Control Equipment

The present invention can also be connected to process monitoring and control equipment such as a
Connected Brewery
Connected chemical production facility
Connected Paint production facility
Connected pharmaceutical processing facility

### EXAMPLE 6

### Home Appliances and Devices

Further the present invention platform can be used with monitorable and or operable home devices such as: Home
Basement Water Level
Basement Humidity
Garage Door Open/Close
Power Usage
Humidity/Temp
No Wi-Fi or Internet required
Thermostat control
Airflow
Remote Thermostats (Multi Thermostats)

### EXAMPLE 7

### Exemplary components of the Present Invention

Platform, Device Management, Analytics, and Connectivity (from $9 a month)

Serial Bus interface
For Off-highway Vehicles—SAE J1939 and Can Open
For Marine—NMEA 2000
For Mowers
For automotive—
For First robotics
For Process Equipment

12 channel analog I/O allows the Connector to convert almost any existing device to a connected device!

Narrow Band connectivity through Cell (Low Cost!)

Direct connect with Bluetooth—Optional

GPS positioning—Optional

Movement and acceleration sensor—Optional

Custom “White Labeled” app based on our existing platform to reduce initial launch cost

### Connectivity of the Platform

Sim based cell connectivity

Satellite as an option

### EXAMPLE 8

### Exemplary Functions and Tasks Performed by the Present Invention

### Options of

Roll over or accident monitoring:
Built-in sensors can automatically alert an OnStar Advisor With Injury Severity Prediction, Advisors can help make first responders aware of the possible severity of the crash and injuries.

Stolen Vehicle Assistance
Pinpoint location of missing asset and work with authorities to retrieve

Vehicle Diagnostics
Monitor vehicles operating systems and provides regular updates about the vehicles health

Marketplace—
Use the mobile app to order correct parts

Maintenance notifications
Receive notifications when maintenance is due
Schedule maintenance with local dealer

On-Demand Diagnostics
Trouble shoot CAN Enabled devices on the machine remotely

Vehicle Locate
Set Boundary alerts, and know where vehicle is at all times

### EXAMPLE 9

### Use Cases for Data Transfer

The platform and device of the present invention allows two-way communication from the smartphone to a powered lawn equipment device anywhere in the world.
How often do we send Data across the Narrow Band network
   Depends on amount of data and use
   Battery charging Status?
The user can not only know the location and current status of the piece of equipment, but the user can also have full communication with the vehicle.
   Send Data when movement occurs
   Send data every (1 min/5 Min/10 Min) when Moving (Optional)
   Send data when position requested
The user can monitor the CAN bus remotely
   Send Data when a flagged event occurs
   Send Specific data at specific time interval (Battery Status)
      When using (1 min/5 Min/10 Min)
      When Charging (1 min/5 Min/10 Min
      When Problem is detected
Receive notification of equipment failures or issues instantly
   Send data upon trigger of failure notice
Receive alerts of any accidents, roll overs, or other potential issues.
   Instantly send data
Activate and deactivate the vehicle or accessories on the vehicle.
   Command hardware when request received
Diagnostics
   Send Data Based on run time
   Send data when Requested
   Send data if flagged issue occurs
QR Code scan to link device—
   Send data at time of request
Market place
   No Data from Device

What is claimed is:

1. A communication device for use with a mobile vehicle having an engine a drive system, a plurality of sensors, including at least a first, second, and third sensor selected from at least one of:
(i) an engine sensor;
(ii) a drive system sensor;
(iii) a position sensor;
(iv) an operational status sensor;
(v) an accessory status sensor;
(vi) an altitude sensor; and
(vii) at least one controller for controlling the operation of at least one of the engine drive systems and accessory.

2. The communication device comprising:
(a) a processor mounted on the vehicle, the processing including at least one input link and at least one output link and a communication link; and
(b) a transceiver in communication with the processor for sending data to and receiving data from a remove processor, wherein the input link is capable of receiving data from each of the first, second, and third sensors, and communicating the received data to the processor, the transceiver and remote processor, and the output link is capable of communicating data received from the remote computer and transceiver of the controller for controlling the operation of at least one of the drive systems and engine.
